(19) United States
(12) Patent Application Publication
(10) Pub. No.: US 2015/0356175 A1
(43) Pub. Date: Dec. 10, 2015

(54) SYSTEM AND METHOD FOR FINDING AND INVENTORYING DATA FROM MULTIPLE, DISTINCT DATA REPOSITORIES

(71) Applicant: KPMG LLP, New York, NY (US)

(72) Inventors: Garrett Flynn, Chicago, IL (US); Josh Close, New York, NY (US); Brian Moon, New York, NY (US); Alex Lamar, New York, NY (US); Narasimhan Kanvar, Philadelphia, PA (US); Ajay Narayan, Portland, OR (US); Lijo Johnson, Short Hills, NJ (US); Tim Tantillo, Philadelphia, PA (US); David Fourie, New York, NY (US)

(21) Appl. No.: 14/297,543

(22) Filed: Jun. 5, 2014

(51) Int. Cl. G06F 17/30

(52) U.S. Cl. CPC G06F 17/30722; G06F 17/30634

(57) ABSTRACT

A system and method of finding and inventorying related data in multiple, distinct tables of a data repository may include storing raw data from multiple, distinct tables in a schema-less design format in a schema-less data repository, where the raw data includes data values and metadata associated with the data values. A first set of data values may be identified from the raw data that matches a search parameter. A first set of metadata associated with the identified first set of data values may be identified. A determination of a second set of metadata related to metadata in the first set of metadata may be made. A second set of data values related to the search parameter may be identified, and an inventory inclusive of metadata that provides an inventory to the identified data values for processing.

### BACKGROUND

Information management systems are used extensively throughout business to manage information and operations. For example, multi-national companies and other organizations (e.g., governmental) or enterprises typically have many individual office sites that have respective information systems that manage local operations. The enterprises generally have a need to be able to collect the information from each of the office sites to be able to create enterprise-level views or reports for management, investors, and government regulators. Large enterprises typically allow the local operations to create and/or manage their respective information management systems. Even when large enterprises have certain central information management systems, it is still quite common that regional operations operate independently from other regional operations with regard to information management. As a result, even when common information technology platforms are utilized, configurations and naming conventions are often different on each different information technology platform. Consider, for example, operations in different countries with different languages.

The current landscape for performing these integrated reporting services is a logistical challenge that can take upwards of a year to perform depending on the size, diversity, and nature of the enterprise and the information management system(s) being used. In the case of enterprises that have operations in over 100 countries and thousands of data repositories that collect transaction data, the disparity between the systems locally, regionally, and internationally are generally significant enough that it is not typically possible to easily identify the same or related data due to the use of different terminology (e.g., “gross sales” versus “total sales”, “customer number” versus “cust. no.” versus “cust_no”, and so on) to refer to the same or related data across different data repositories to generate enterprise-level statistics. As a result, the effort to capture the same or related data across these disparate platforms is a very labor intensive and cumbersome process, and typically done via requests to each location/region to submit operational statistics in spreadsheet form or otherwise. A more recent approach to try and improve reporting capabilities of large organizations has been to perform data warehousing. This approach, however, is being abandoned due to the cost of creating and managing data warehouses.

### SUMMARY

The principles of the present invention provide for a system and process that allows for finding and inventorying data values from multiple, different tables of a data repository. The process may include collecting data from multiple, different tables or data sources, and aggregate or ingest the data into one or more schema-less repository without having to define a structure for the collected data (i.e., schema-less data). Once all the data is in the data repository, the principles of the present invention relate and consolidate common data values by (i) searching for data values, (ii) identifying metadata associated with those data values, (iii) searching for related metadata, and (iv) identifying additional common data values associated with the related metadata. The metadata associated with the data values may be column headers or attributes of the data values that match a search string, for example. The search string may include known data values in a table or source file of a data repository of the type being sought for aggregation (e.g., total sales). The metadata associated with the data values may further include data type, field length, field name, or any other metadata associated with a data field of a data field identified in the search that may be used in identifying common data values as a result of being in data fields with the same data type, field length, similar name, etc. An inventory of metadata, such as header information, from the multiple, different data sources that include the identified data values may be included in an inventory data file so as to operate as a catalog or map to the relevant data sources (i.e., tables of data repositories with the identified data values). By reducing the number of data sources, improved efficiency may result during later processing.

One embodiment of a method of finding and inventorying related data in multiple, distinct data repositories may include storing raw data from multiple, distinct tables of a data repository in a schema-less design format in a schema-less data repository, where the raw data includes data values and metadata associated with the data values (e.g., data files). A first set of data values may be identified from the raw data that matches a search parameter. A first set of metadata associated with the identified first set of data values may be identified. A determination of a second set of metadata related to metadata in the first set of metadata may be made. A second set of data values related to the search parameter may be identified, and an inventory dataset inclusive of metadata, such as header information, from the multiple, distinct tables may be generated from the tables inclusive of the identified data values. Alternatively, an aggregated dataset related to the search parameter inclusive of the identified first and second sets of data values optionally along with associated metadata may be generated. The identified data values may be used to generate enterprise information, such as gross sales, throughout all regions of an enterprise.

One embodiment of a system for finding and inventorying related data in multiple, distinct tables of a data repository may include a storage unit configured to store data, and a processing unit in communication with the storage unit. The processing unit may be configured to cause raw data from multiple, distinct tables of the data repository to be stored in a schema-less design format in a schema-less data repository in the storage unit. The raw data may include data values and metadata associated with the data values. A first set of data values may be identified from the raw data that matches a search parameter. A first set of metadata associated with the identified first set of data values may be identified. A second set of metadata related to metadata in the first set of metadata may be determined by the processing unit. A second set of data values related to the search parameter may be identified, and an inventory dataset inclusive of metadata, such as header information, from the multiple, distinct tables may be generated from the tables inclusive of the identified data value. Alternatively, an aggregated dataset related to the search parameter inclusive of the identified first and second sets of data values may be aggregated. The identified data values may be used to generate enterprise information, such as gross sales throughout all regions of a company.

### BRIEF DESCRIPTION

A more complete understanding of the method and apparatus of the present invention may be obtained by reference to the following Detailed Description when taken in conjunction with the accompanying Drawings wherein:

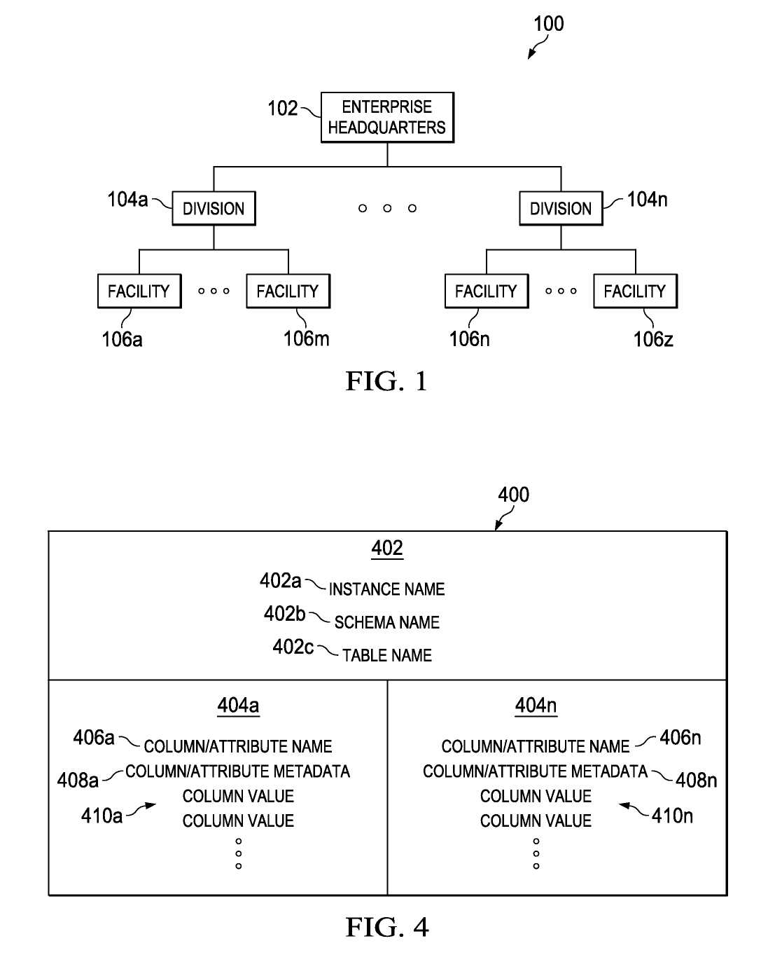

FIG. 1 is an illustration of an illustrative hierarchical structure of an enterprise, such as a corporation or governmental entity (enterprise);

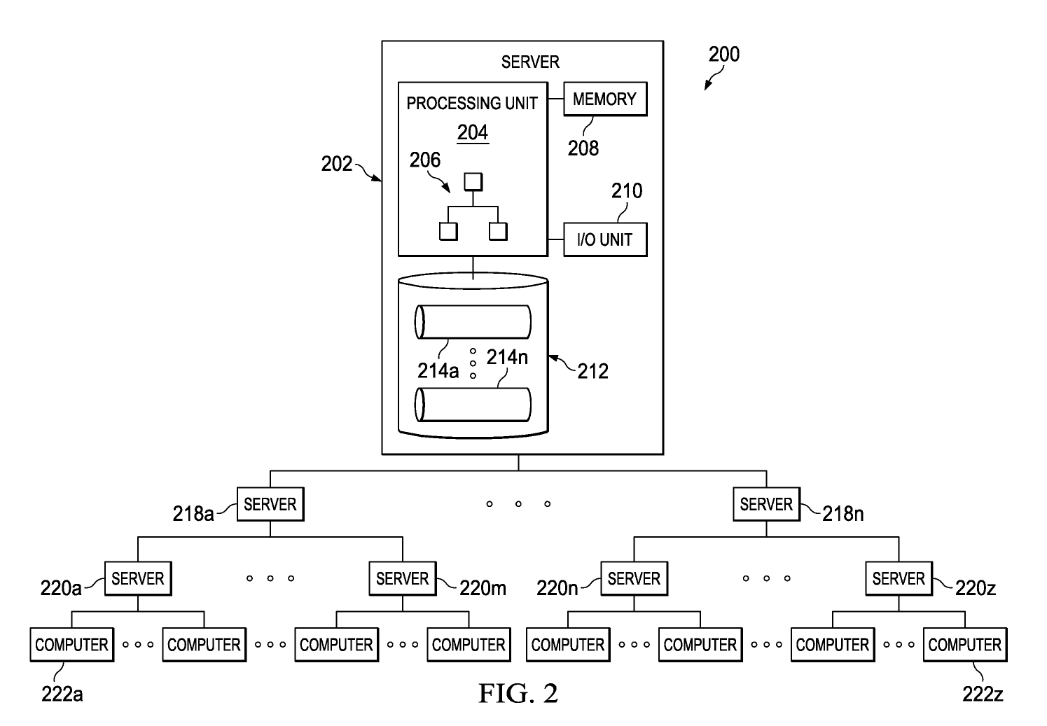

FIG. 2 is an illustration of an illustrative network configuration of the enterprise of FIG. 1;

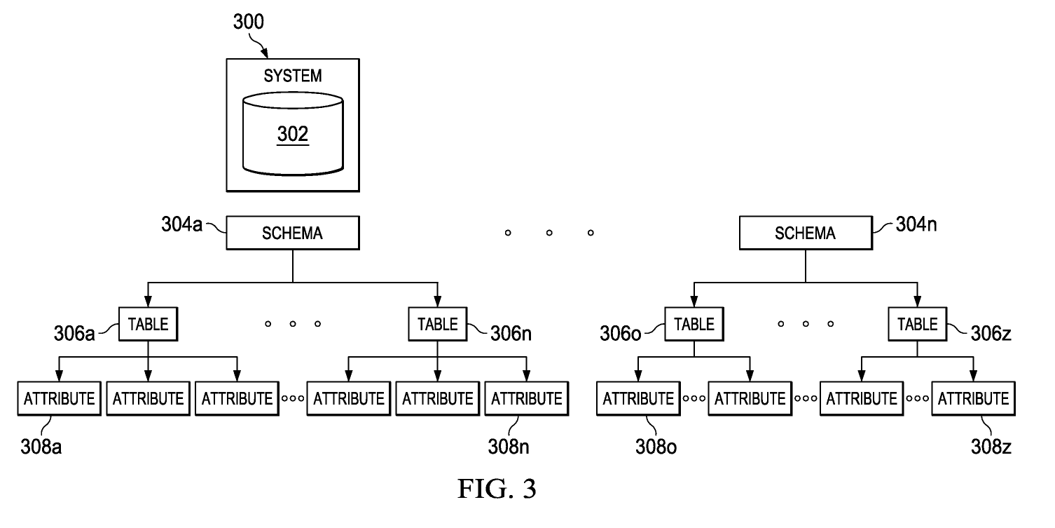

FIG. 3 is an illustration of an illustrative enterprise information management system inclusive of a plurality of tables, as understood in the art;

FIG. 4 is a listing of an illustrative table that is utilized to store information utilized by an enterprise within an enterprise management system, as understood in the art;

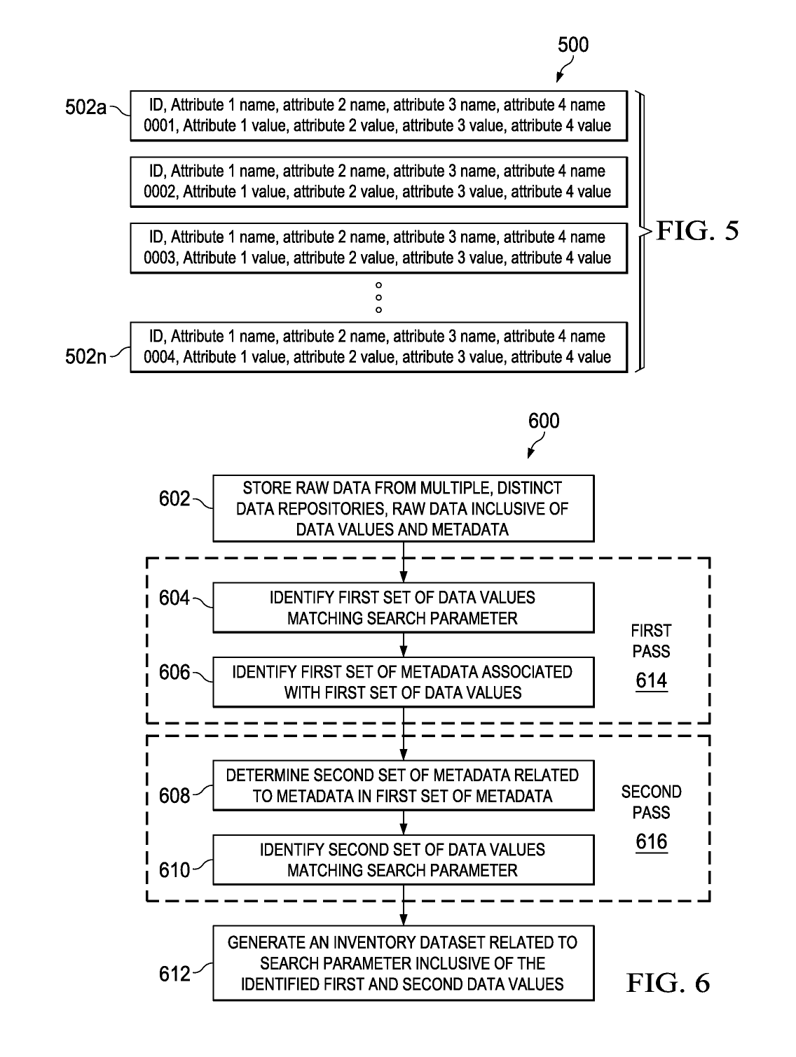

FIG. 5 is a data set inclusive of raw data from different tables of one or more data repositories from one or more information management systems of an enterprise;

FIG. 6 is a flow diagram of an illustrative process for aggregating and processing enterprise data from multiple, distinct tables of a data repository in accordance with the principles of the present invention;

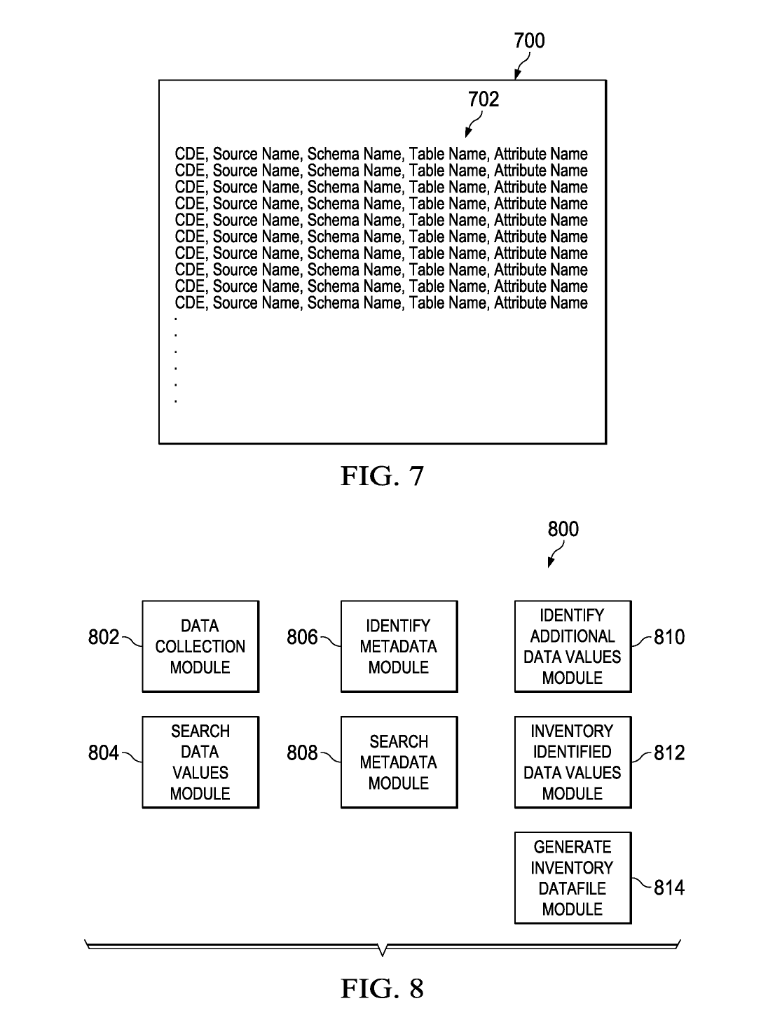

FIG. 7 is a data file inclusive of an illustrative inventory dataset identified and processed utilizing the process of FIG. 6; and

FIG. 8 is a block diagram of an illustrative set of software modules executable by a processing unit for performing the principles of the present invention.

### DETAILED DESCRIPTION OF THE DRAWINGS

With regard to FIG. 1, an illustration of an illustrative hierarchical structure 100 of an enterprise, such as a corporation or governmental entity, is shown. The structure 100 may include an enterprise headquarters 102 that includes multiple divisions 104a-104n (collectively 104). Each of the divisions 104 may include multiple facilities 106a-106m and 106n-106z, respectively (collectively 106). As understood in the art, each of the enterprise headquarters 102, divisions 104, and facilities 106 may utilize distinct data repositories, and possibly distinct information management systems, for collecting, managing, and processing operational data of the enterprise. For example, the operational data may include customer names, customer addresses, customer policies (in the case of an insurance company), customer payments, and so forth.

Because enterprises, especially large, multi-national enterprises, often use different enterprise management systems with data repositories, such as SAP, Oracle, and other enterprise-scale information management systems, management of respective information management systems, naming conventions, data structures, and a variety of other aspects of managing information of the enterprise 100 may vary. As a result of local management of information management systems, the ability for enterprise-level information that enables senior management to quickly access and generate enterprise-level information (e.g., total sales revenue) is typically not possible. It is not uncommon for such enterprise-level information to take upwards of 9 to 12 months to be generated as a result of enterprise management systems having one or more data repositories with tens or hundreds of thousands of tables being used to manage operational data of the enterprise. Such limitations are often a result of legacy information management systems being utilized by large enterprises, but such limitations may also exist due to the nature of enterprise information management systems, legacy or current.

With regard to FIG. 2, an illustration of an illustrative network 200 configuration of the enterprise of FIG. 1 is shown. The network configuration 200 may include a server 202 inclusive of a processing unit 204 that may include one more computer processors, as understood in the art. The processing unit 204 may be configured to execute software 206 to perform functions in accordance with the principles of the present invention. The processing unit 204 may be in communication with a memory 208 to store data and/or software, as understood in the art. The processing unit 204 may be in communication with an input/output (I/O) unit 210 configured to communicate data via a communications network and a storage unit 212. The storage unit 212 may be configured to store data repositories 214a-214n (collectively 214). The data repositories 214 may be configured with tables (not shown) to store inventory and/or enterprise-level information that may be collected from data repositories and/or tables of lower-level enterprise operations. The network configuration 200 may further include servers 218a-218n (collectively 218) that may be operated at a division level, such as divisions 104 of FIG. 1. Servers 220a-220m and 220n-220z (collectively 220) may be operated at a facility level, such as facilities 106 of FIG. 1. Computers 222a-222n (collectively 222) may be individual computers, such as point-of-sale devices, personal computers, and/or any other computing or data collection/generation device or system, as understood in the art. The computers 222 may be in communication with local servers 220 that may have enterprise information management systems used to collect and inventory and/or aggregate data of each facility. As understood in the art, individual facilities often utilize and maintain separate information management systems. Still yet, divisions of enterprises may operate independent of other divisions, especially when each of the divisions operate in different geographic regions, such as different countries, from other divisions.

The illustrative network configuration shows four levels of computing systems. It should be understood that many more levels and layers of complexity of network architecture is often used within large enterprises, which creates a large-scale information management system that operate data repositories that have tens of thousands or hundreds of thousands of tables in which information generated by each facility of an organization is stored. As an example, in the case of a multi-national retail operation, such as a retail store, sales of clothing and other products may be generated in vast amounts. Moreover, information of customers may be collected and stored for a variety of different purposes, including returns, marketing, demographic assessment, and many other reasons, as understood in the art. The reason for data repositories utilizing tens and hundreds of thousands of tables is to be able to provide for fast searching within the data repositories. In other words, many data repositories utilize relatively “shallow” tables, but use the many tables so as to increase the speed of searching for data contained therein. As a result, however, the ability to aggregate the data from each of the tables can be incredibly time consuming and difficult because it is difficult to keep track of which tables include specifically which type of information.

With regard to FIG. 3, an illustration of an illustrative enterprise information management system 300 inclusive of a data repository 302 that manages a plurality of tables, as understood in the art, is shown. The data repository 302 may include a set of schemas 304a-304n (collectively 304) that includes multiple tables 306a-306n (collectively 306). Each of the tables 306 may include attributes 308a-308n (collectively 308) that define attributes of data values contained in the respective tables 306. The number of tables 306 may depend on the data repository (e.g., SAP, Oracle, etc.), size of the enterprise, configuration of the enterprise, geographic diversity of the enterprise, configuration of the data repository 302, configuration of the tables 306, and so forth. As understood in the art, and as previously described, the number of tables of a relatively large enterprise may range upwards of 100,000, and be used to store operational data of the enterprise, such as an accounting firm, retail chain, or otherwise. The information contained in the tables 306 may have different naming conventions at each of the different facilities or regions, which is one reason why creation of enterprise-level data is time consuming and challenging. It should also be understood that not all enterprises use a single or common information management system platform for managing operational and other data, which compounds the problem of identifying and consolidating common data that is used to create enterprise-level data.

With regard to FIG. 4, a listing of an illustrative table 400 (i.e., source file) that is utilized to store information utilized by an enterprise within an enterprise management system, as understood in the art, is shown. The table 400 may include a header 402 that includes certain table and/or data repository-level information, including table name 402a, schema name 402b, catalog name 402c, and any other information, as understood in the art. The header 402 is metadata, and may be used by an enterprise information inventorying or aggregation process, as further described hereinbelow.

The table 400 may include a number of columns 404a-404n (collectively 404) that respectively include a column/attribute name 406a-406n (collectively 406), column/attribute metadata 408a-408n (collectively 408), and data values or column values 410a-410n (collectively 410). The column names 406 and column metadata describe the nature of the data values 410, and are both metadata associated with the data values 410. The data values 410 may be operational data (e.g., customer names, sales values, etc.) or management data (e.g., employee names, employee hours, etc.). The column names 406 and column metadata 408 often vary between offices, regions, information management system platforms, and so on. Although described as a structured data repository with columns and rows, it should be understood that source files, tables, and/or data repositories may have alternative configurations, as understood in the art.

With regard to FIG. 5, an illustrative dataset 500 inclusive of raw data 502a-502n (collectively 502) from different tables of one or more data repositories being operated by one or more information management systems of an enterprise is shown. The dataset 500 may be included in a schema-less repository as the dataset 500 may include raw data 502 from all tables (i.e., native sources) being managed by information management system(s) of an enterprise. The raw data 502 may include table header information and operational data that include both data values and metadata (e.g., column names and/or other attributes) from a plurality of tables of data repositories from the one or more enterprise management systems. In particular, a document identifier, attribute names, attribute values, etc., may be included in the dataset 500. Although not shown, additional metadata associated with the data values may be included, such as data type, field name, field length, and so on, that may be used in a searching process (see FIG. 6) for data of the same type for use in finding and inventorying or aggregating the data values in multiple, different data tables.

As is evident from the configuration of the dataset 500, the dataset 500 is configured as schema-less data, which makes it faster and easier to create as compared to a structured data file since data formats from other data files do not need to be known when copying into the dataset 500. The dataset 500 may include data of all tables determined to be part of a data repository or inclusive of data that may be used in creating accurate enterprise-level information, such as total company sales. It should be understood that the dataset 500 is illustrative and that alternative configurations of the dataset 500 may be utilized in accordance with the principles of the present invention. For example, multiple data files or tables may be used to store the raw data 502. Still yet, the raw data 502 may be configured in an alternative manner (e.g., table headers separated in a separate dataset from the operational data). It should also be understood that rather than ingesting the raw data from the multiple, distinct tables, that the principles of the present invention may be executed directly on the raw data in their respective native database schema/table structure.

With regard to FIG. 6, a flow diagram of an illustrative process 600 for finding and inventorying and processing enterprise data from multiple, distinct tables of data repositories in accordance with the principles of the present invention, is shown. The process 600 may start at step 602, where raw data from multiple, distinct tables may be stored in a schema-less repository (e.g., text file). The raw data may be inclusive of data values and metadata associated with the data values from each of the respective tables. The distinct tables may operate within one or more data repository of an enterprise information management system, as understood in the art. It should also be understood that the data repositories may be from different information management systems. In general, the raw data will be drawn from tables that store operational data of an enterprise.

At step 604, a first set of data values matching a search parameter may be identified in the schema-less data repository. The search parameter may include known data values within at least one of the distinct tables, thereby providing for data fields within which particular types of data are to be found. In one embodiment, the search parameters may be specific data values or sample values, such as “*1234*” for a customer account number, where the asterisks are wildcard identifiers. A variety of different wildcard identifiers and functions (e.g., no wildcard requires an exact match, wildcard preceding a search parameter returns anything plus a match of the search parameter, wildcard proceeding or following a search parameter returns any match of the search parameter plus anything, an so on) may be used. Because the sample values are known to exist within certain data values being sought, other data values of the same type can be identified, thereby enabling the process to be automated, as further described herein. The data values may include smallest logical atomic attributes, which are the smallest data values that are collected and stored in tables, as opposed to data values that are a combination of other logical atomic attributes (e.g., account identifiers that combine account numbers and geographic location). By using sample value(s) or search parameter(s) that are included within a logical atomic attribute as search string(s), any other data values that includes the sample value(s) may be identified and included or not included when finding the desired data values.

At step 606, a first set of metadata associated with the first set of data values may be identified in the schema-less data repository. In identifying the first set of metadata, the process 600 may identify some or all of the metadata that is stored in association with a data field of the data value(s) that were identified in step 604. That is, data values that match the search parameters may be used to identify the same or other tables in which the data values being sought can be located. The metadata may include table name, catalog name, schema name, field name, field length, field type, data type, and so on that can provide guidance (i.e., subsequent search parameters) to locating any other data values that can be used in creating the enterprise-level information being sought.

At step 608, a second set of metadata related to metadata in the first set of metadata may be determined. The second set of metadata may be determined to be related to the first set of metadata if the name of the metadata matches any of the first set of metadata (e.g., “account num”). In one embodiment, a predetermined set of metadata naming alternatives may be utilized to assist with matching a first set of metadata. Ontology modeling or other modeling, as understood in the art, may be utilized in accordance with the principles of the present invention, as well, to identify similar metadata that refers to the same data type (e.g., “Acct#” and “Acct_Num” are related metadata). The process at step 608 may self-generate a list of metadata associated with a data value that matched the search parameters, and that list of metadata may be used to search through metadata of other tables being stored in the schema-less data repository. For example, step 608 may perform a search using one or more metadata to find other metadata that matches any of the metadata identified in step 606 to help locate metadata that indicates or suggests that the same type of data is contained (i) in other parts of the table in which the search parameters matched a data value or (ii) in different tables in which the search parameters did not match any data values in the first pass at step 606.

At step 610, a second set of data values related to the search parameter may be identified. The second set of data values may simply be identified as data values associated with the second set of metadata (e.g., all data values within a column having a column name that matched a column name associated with a data value that matched a search parameter).

At step 612, an inventory dataset related to the search parameter inclusive of the identified first and second data values and associated metadata may be generated. The inventory dataset may be formed by copying metadata from the tables in which the identified data values were found in steps 604-610 into a separate data repository, where the data repository for the inventoried dataset may be as basic as a text file. The inventory dataset may operate as a reference to the identified data values. By creating the inventory dataset, a limited set of data files may be utilized for further processing. Alternatively, an aggregated dataset may be formed by data file copying the raw data inclusive of the data values and associated metadata from each of the multiple, distinct tables.

As an example, suppose ten source information management systems exist, and each source system has 3,500 tables, which equates to 35,000 tables that have to be processed. By using the principles of the present invention, a subset of tables that contains data that is relevant to the information being sought may be identified. If, for example, only 1,500 of the 35,000 tables are deemed “relevant” due to including data values found in the search process, the remaining 33,500 tables do not have to be processed. This inventory of 1,500 tables may thereafter be fed downstream to profile the content/data in the 1,500 tables.

As shown, steps 604 and 606 define a first pass process 614 that is used to identify matching data values and associated metadata, and steps 608 and 610 define a second pass process 616 that is used to identify additional data values related to the search parameter. Because the first and second pass processes 614 and 616 are automated or semi-automated, the principles of the present invention provide a significant improvement over conventional manual processes that currently require a user to review all tables or data sources to locate or identify related data values that can be used to generate certain enterprise-level information. It should be understood that the principles of the present invention may utilize non-table data sources that operate within or outside of a data repository, and that the term tables may include such non-table data sources.

Resulting from the process of FIG. 6 may be a data file inclusive of at least a portion of the following parameters:

(i) schema name (metadata from each data repository containing a table with a matching data value),

(ii) table name (metadata from each table containing a matching data value),

(iii) column name (metadata from each table column containing a matching data value),

(iv) search parameter or control value (value to be searched in the schema-less repository), and

(v) standardized name or attribute (logical name of attribute, such as a column name, associated with the search parameter and optionally submitted with the search parameter).

It should be understood that additional and/or alternative parameters may be utilized in accordance with the principles of the present invention.

As an example, multiple column names can be returned for a standardized name or attribute. For a search parameter, “bike,” search results may produce data values “Yellow Road Bike” and “Mountain Bike” along with respective column names “PRODUCT_NM” and “PRODUCT_CATEGORY,” which shows that each table or data source may use a different name for an attribute than other tables. In one embodiment, rather than using different attribution names, such as different column names, the principles of the present invention may replace the different names with a common name (e.g., “Product_Name”) for each of the related data values to simplify data processing thereafter.

In one embodiment, a total number of tables from which data values in the first and second set of data values were identified prior to being stored in a schema-less data repository may be counted. Additionally, a total number of data values identified in each of the tables may be counted. These counts may be utilized for error checking or performing other accounting to ensure that all of the data values being sought are utilized.

With regard to FIG. 7, a data file 700 inclusive of an illustrative inventory of metadata, such as header information 702, collected from data repositories and/or tables inclusive of data values identified in a search through the data repositories is shown. The metadata 702 provides for an inventory listing that enables a system to identify tables and specific locations within those tables in which data values, such as sales values, identified in the search may be located for further processing. As shown, the metadata 702 may include a variety of different header information, including critical data element (CDE) or name of data values, source name (name of system), schema name, table name, and attribute name, that provides for identifying location of specific data values along with other information not specifically directed to location identification. It should be understood that the specific metadata 702 listed is illustrative, and that additional or less metadata may be inventoried in accordance with the principles of the present invention. For example, the metadata may include links or other information that provides a listing of which data repositories that include the identified data values determined from the search may be stored. The data file 700 may be schema-less or alternatively include a scheme or data format. As shown, no data values are included with the inventory. A time stamp that identifies a date and time of the inventorying may also be included in the data file 700.

In an alternative embodiment, the principles of the present invention may be configured to aggregate the raw data from all data repositories collected in the dataset 500 or schema-less repository of FIG. 5 into an aggregated dataset. The aggregated dataset may include each of the metadata of each data repository in which data values associated with or related to a search parameter is identified. Also included in the aggregated dataset may be data values and associated metadata (e.g., column name, field name (not shown), field type (not shown), field length (not shown), and so on). From the aggregated dataset, information may be generated therefrom. The information generated from the aggregated dataset may be enterprise-level data, such as company total sales, regional sales, etc. In addition to search results, the principles of the present invention may be time stamped to enable a user to determine when the data aggregation process is executed.

With regard to FIG. 8, a block diagram of an illustrative set of software modules 800 executable by a processing unit for performing the principles of the present invention, is shown. The software modules 800 may be configured to be executed on a server, such as server 202 of FIG. 2. Alternatively, the software modules 800 may be executed on a third-party server or other server via a communications network, such as the Internet, with respect to a server of an enterprise, and be used to access data repositories being managed by the enterprise.

The modules 800 may include a data collection module 802 configured to collect data from multiple, distinct tables. The multiple, distinct tables may be tables operating within a single data repository or multiple data repositories of information management system and across one or more computing systems of the enterprise. Alternatively, the multiple, distinct tables may be part of or stored by multiple, distinct information management systems operating within different operations of the enterprise. In collecting the data, raw data inclusive of data values and metadata of the multiple, distinct tables may be collected and stored in a single or multiple aggregated data repositories, (e.g., schema-less data repository) as previously described. The schema-less data repository may be configured to store data in a schema-less design. Alternatively, a structured data format may be utilized to store the aggregated data. However, using a schema-less design may provide for flexibility and simplicity that is otherwise not afforded when using a structured data format.

A search data values module 804 may be configured to search data values within the schema-less repository, such as that shown in FIG. 5. In searching data values in the schema-less repository, the search module 804 may be configured to limit the search to data values, as opposed to metadata contained within the schema-less repository. The module 804 may be configured to use wildcards when searching for data values, as understood in the art.

An identifying metadata module 806 may be configured to identify metadata associated with data values identified by the module 804. The metadata associated with the data values may include data repository and/or table header information (e.g., schema name, table name), information associated with each individually identified data value (e.g., column name), and information associated with an individual data value (e.g., field attribute) identified by the search module 804. More specifically, the header information of a table may include data repository name, schema name, catalog name, and so on. Metadata associated with a particular data value identified by the search module 804 may include field name, field length, datatype, and so on. Metadata associated with data values associated with the data value(s) identified by the module 804 may include column name, for example.

A search metadata module 808 may be configured to search for metadata identified from the module 806. That is, any metadata that is identified from the module 806 may be used to search for other metadata in the schema-less repository that is indicative of having associated data values that the same type as or are related to data values identified by the module 804. In other words, the search metadata module 808 may be configured to identify all metadata that is indicative of having data values of the type being searched using the search parameter(s) that can be used for producing enterprise-level information, for example. A variety of processing techniques for matching or determining that other metadata is related may be used, as previously described.

An identify additional data values module 810 may use the search results from modules 806 and 808 to identify additional data values in the schema-less repository that are of the type being searched for in the search parameters. That is, the data values being identified by module 810 may be identified by using metadata that suggests that the data values could be or are of the same type identified by module 804.

An inventory identified data values module 812 may be configured to aggregate the identified data values from module 810 into a data repository. The data repository, which may store an inventory dataset related to the search parameter(s), may be a schema-less repository that stores both data values (i.e., actual data) and metadata associated with the data values, such as that shown in FIG. 7. It should be understood that rather than inventorying the identified data values that the data values may be aggregated as previously described.

A generate inventory data file module 814 may be configured to create a data file with the inventory information identified or created by module 812. Such a data file may be schema-less or otherwise. It should be understood that the modules are illustrative and additional, fewer, and/or alternative modules configured to perform the same or similar functions described herein may be utilized. Moreover, a combination of two or more modules is also possible.

While one embodiment provides for the user to submit a search parameter for known, actual data value(s), the principles of the present invention may be configured to search for known metadata associated with actual data values that the user desires to include as part of enterprise data. It should be understood that search parameters may be submitted to an aggregation search process via a data file, such as a CSV data file or any other formatted or unformatted data file, as understood in the art. In an alternative embodiment, a manual process of approving and/or selecting other metadata related to a first set of metadata via a user interface may be utilized in accordance with the principles of the present invention.

The previous description is of a preferred embodiment for implementing the invention, and the scope of the invention should not necessarily be limited by this description. The scope of the present invention is instead defined by the following claims.

What is claimed:

1. A method of finding and inventorying related data in multiple, distinct tables, said method comprising:
identifying, by a processing unit, a first set of data values from raw data from the multiple, distinct tables that matches a search parameter;
identifying, by the processing unit, a first set of metadata associated with the identified first set of data values;
determining, by the processing unit, a second set of metadata related to metadata in the first set of metadata;
identifying, by the processing unit, a second set of data values related to the search parameter; and
generating, by the processing unit, an inventory dataset being inclusive of metadata from the multiple, distinct tables inclusive of the identified first and second sets of data values to provide an inventory to the identified data values for processing.

2. The method according to claim 1, wherein determining the second set of metadata includes searching for metadata in the schema-less data repository that matches metadata in the first set of metadata.

3. The method according to claim 1, wherein identifying the first set of metadata includes identifying an identifier of a column inclusive of each of the data values in the first and second sets of data values along with a table name of each table from which each of the data values in the first and second sets of data values were stored in their native source.

4. The method according to claim 3, further comprising storing, by the processing unit, each of the attributes of the data values in the first and second sets of data values.

5. The method according to claim 4, further comprising identifying a schema name and catalog name associated with each of the tables from which the data values from the first and second sets of data values were stored in their native source.

6. The method according to claim 1, wherein identifying the second set of metadata includes identifying the second set of metadata by matching metadata from the first set of metadata with metadata in the schema-less data repository.

7. The method according to claim 6, wherein identifying the second set of metadata further includes identifying the second set of metadata by using at least one parameter indicative of a data field in which the first set of data values are stored in the multiple, distinct tables.

8. The method according to claim 1, further comprising:
counting, by the processing unit, a total number of tables from which data values in the first and second set of data values were identified prior to being stored in a schema-less data repository ; and
counting, by the processing unit, a total number of data values identified in each of the tables.

9. The method according to claim 1, further comprising storing, by a storage unit, the raw data from the multiple, distinct data repositories having a schema-less design format in a schema-less data repository, the raw data including data values and metadata associated with the data values.

10. The method according to claim 9, wherein storing the raw data in the schema-less data repository includes storing the raw data in a text data file.

11. The method according to claim 1, further comprising processing a data file inclusive of a search parameter to identify a data value within the schema-less data repository.

12. A system for finding and inventorying related data in multiple, distinct tables, said system comprising:
a storage unit configured to store a data repository; and
a processing unit in communication with said storage unit, and configured to:
identify a first set of data values from raw data from the multiple, distinct tables that matches a search parameter;
identify a first set of metadata associated with the identified first set of data values;
determine a second set of metadata related to metadata in the first set of metadata;
identify a second set of data values related to the search parameter; and
generate an inventory dataset being inclusive of metadata from the multiple, distinct tables and inclusive of the identified first and second sets of data values to provide an inventory to the identified data values for processing.

13. The system according to claim 12, wherein said processing unit, in determining the second set of metadata, is configured to search for metadata in the schema-less data repository that matches metadata in the first set of metadata.

14. The system according to claim 12, wherein said processing unit, in identifying the first set of metadata, is further configured to identify an identifier of a column inclusive of each of the data values in the first and second sets of data values along with a table name of each table from which each of the data values in the first and second sets of data values were stored in their native source.

15. The system according to claim 14, wherein said processing unit is further configured to store each of the attributes of the data values in the first and second sets of data values.

16. The system according to claim 15, wherein said processing unit is further configured to identify a schema name and catalog name associated with each of the tables from which the data values from the first and second sets of data values were stored in their native source.

17. The system according to claim 12, wherein said processing unit, in identifying the second set of metadata, is further configured to identify the second set of metadata by matching metadata from the first set of metadata with metadata in the schema-less data repository.

18. The system according to claim 15, wherein said processing unit, in identifying the second set of metadata, is further configured to identify the second set of metadata by using at least one parameter indicative of a data field in which the first set of data values are stored in the multiple, distinct tables.

19. The system according to claim 12, wherein said processing unit is further configured to:
count a total number of tables from which data values in the first and second set of data values prior to being stored in a schema-less data repository were identified; and
count a total number of data values identified in each of the tables.

20. The system according to claim 12, wherein said processing unit is further configured to cause the raw data from multiple, distinct data repositories to be stored with a schema-less design format in a schema-less data repository in said storage unit, the raw data including data values and metadata associated with the data values.

21. The system according to claim 20, wherein said processing unit, in storing the raw data in the schema-less data repository, is further configured to store the raw data in a text data file.

22. The system according to claim 12, wherein said processing unit is further configured to process a data file inclusive of a search parameter to identify a data value within the schema-less inventory.
